(19) United States
(12) Patent Application Publication
(10) Pub. No.: US 2023/0126539 A1
(43) Pub. Date: Apr. 27, 2023

(54) METHOD AND APPARATUS FOR PROVIDING PREDICTED NAVIGATION-DATA PARAMETERS WITH EMBEDDED CORRECTION DATA

(71) Applicant: HERE GLOBAL B.V., Eindhoven (NL)

(72) Inventors: Saara Kuismanen, Tampere (FI); Pekka-Henrik Niemenlehto, Nokia (FI)

(73) Assignee: HERE GLOBAL B.V., Eindhoven (NL)

(21) Appl. No.: 17/510,504

(22) Filed: Oct. 26, 2021

(51) Int. Cl. G01S 19/25; G01S 19/40; G01S 19/39; G01S 19/55

(52) U.S. Cl. CPC G01S 19/256; G01S 19/40; G01S 19/55; G01S 19/393

(57) ABSTRACT

A method, apparatus and computer program product provide one or more of navigation-data parameters or correction-model parameters for one or more navigation satellites. In the context of a method, the method includes receiving (i) navigation data regarding one or more of a position of a respective navigation satellite or a clock offset of a clock of the respective navigation satellite and (ii) correction data regarding corrections to one or more of the position or the clock offset of the respective navigation satellite. The method also includes predicting an orbit and the clock of the respective navigation satellite based on the navigation data and the correction data. The method further includes fitting at least one of the navigation-data parameters or the correction-model parameters to the predicted data and, following the fitting, providing the at least one of the navigation-data parameters or the correction-model parameters to one or more navigation devices.

### TECHNOLOGICAL FIELD

An example embodiment relates generally to a method, apparatus and computer program product for providing navigation-data parameters and/or correction-model parameters, such as navigation-data parameters that are defined utilizing predicted data and that have correction data embedded therein. The navigation-data parameters having the embedded correction data are provided to one or more navigation devices to permit a navigation device to determine the position of a navigation satellite and, in turn, the position of the navigation device in an accurate manner even though the correction data need be updated less frequently.

### BACKGROUND

Positioning and navigation solutions commonly depend upon a Global Navigation Satellite System (GNSS) having a plurality of GNSS satellites. The signals transmitted by a GNSS satellite are received by GNSS receivers embedded in or otherwise carried by a variety of different location-aware devices or by GNSS receivers of an assisted data service that, in turn, provides information derived from the signals transmitted by the GNSS satellite to one or more location-aware devices. For example, smartphones, smart watches, vehicles, drones and other location-aware devices include GNSS receivers in order to allow the position of the device to be determined. In some instances, the device may include a navigation system and/or a navigation application that is dependent upon the signals transmitted by a GNSS satellite in order to determine the position of the device and to provide navigational assistance. The number of devices that include GNSS receivers is growing rapidly with more types of devices including devices, such as Internet of Things (IOT) devices, with limited amounts of computational resources including GNSS receivers.

The GNSS family includes several satellite constellations including the Global Positioning System (GPS) and the Globalnaya Navigatsionnaya Sputnikovaya Sistema (GLONASS) system. Other GNSS satellite constellations include the Beidou system and the Galileo system. In addition to these global satellite constellations, several regional Satellite-Based Augmentation Systems (SBAS), such as the Quazi-Zenith Satellite System (QZSS), Multifunctional Transport Satellites (MTSAT) Satellite Augmentation System (MSAS), Wide Area Augmentation System (WAAS), European Geostationary Navigation Overlay Service (EGNOS), GPS-Aided Geostationary (GEO) Augmented Navigation (GAGAN) and System for Differential Correction and Monitoring (SDCM) and the Indian Regional Navigation Satellite System (IRNSS) having an operational name of NavIC (Navigation with Indian Constellation), have been developed.

In a GNSS system, a navigation satellite orbiting the Earth transmits navigation signals including ranging codes and navigation data interleaved with the ranging codes that a GNSS receiver receives and utilizes to determine the position of the GNSS receiver and, in turn, the device in which the GNSS receiver is embedded. The ranging code allows the GNSS receiver to determine the time required for the signals to travel from the navigation satellite to the GNSS receiver, which correlates to the distance between the navigation satellite and the GNSS receiver. The navigation data includes a set of parameter values of an orbit model defining the orbit of the navigation satellite for a limited period of time. The parameter values are known as ephemeris data. The ephemeris data may be utilized by the GNSS receiver to determine the position the navigation satellite relative to a predefined coordinate system at particular instances of time. Based on the positions of a plurality of navigation satellites, the clock information of the navigation satellites, such as the clock offsets of the navigation satellites relative to GNSS time, and the time required for the signals broadcast by the navigation satellites to be received by the GNSS receiver, the GNSS receiver is configured to determine its position.

A GNSS receiver that relies solely upon signals received from navigation satellites may not be capable of determining its position with sufficient accuracy and/or in a sufficiently rapid manner in certain situations. For example, in instances in which the signal conditions between a navigation satellite and a GNSS receiver are weak, such as in urban areas and, more particularly, within urban canyons, the position of the GNSS receiver may not be able to be accurately determined. Additionally, the time-to-first-fix (TTFF), that is, the time required for a GNSS receiver to initially determine its position based upon signals received from a navigation satellite may be longer than desired for certain applications, such as a navigation application that demands the relatively timely determination of position.

In order to improve upon the performance of a GNSS receiver in relation to the accuracy and timeliness with which the position of the GNSS receiver is determined, assisted-GNSS technology was developed. In this regard, assisted-GNSS recognizes that the ranging codes transmitted by a navigation satellite would generally be received by a GNSS receiver, even in relatively weak signal conditions, but that the navigation data interleaved with the ranging codes may become too noisy and erroneous for successful demodulation in certain circumstances, such as in an urban environment. As such, assisted-GNSS technology utilizes a global monitoring network for capturing the navigation data transmitted by navigation satellites and for providing at least some of the navigation data to a GNSS receiver as assistance data, such as via the Internet or other terrestrial communication systems or networks. In one example, an assisted GNSS Positioning service may provide GNSS assistance data, such as via, e.g., the HERE GNSS API from HERE Technologies that provides correction and assistance data including predicted assistance data.

Assistance data generally includes a set of information elements carrying information identifying a reference location and a reference time as well as navigation data from a navigation satellite. Access to the assistance data and potentially to additional information, such as the reference frequency of a modem utilized by the GNSS receiver, by the GNSS receiver may improve the performance of the GNSS receiver. For example, the availability of assistance data may permit the time-to-first-fix to be reduced, such as to about 5 to 10 seconds, for a position determination having an accuracy of about 5 meters in contrast to a time-to-first-fix that may be in a range of about 30 to 40 seconds for a GNSS receiver without assistance data.

The ephemeris data that defines the orbit model has a certain, limited lifetime, such as 2 to 4 hours, during which the parameter values are valid and the position of the satellite can be estimated based thereupon with a desired accuracy. Following the transmission of the ephemeris data, the accuracy with which the position of the navigation satellite is defined by the parameter values decreases as the age of the ephemeris data for the satellite increases. Eventually, the GNSS receiver must receive a new set of ephemeris data for the navigation satellite if the position of the GNSS receiver is to be determined with sufficient accuracy. However, the acquisition of ephemeris data from the navigation satellite may be a time-consuming process taking up to several minutes or may require substantial network access.

As a result, an Ephemeris Extension Service (EES) is available to extend the useful lifespan of the ephemeris data with the extension based on a model of the orbit of the navigation satellite and, in some instances, the clock on-board of the navigation satellite. In a typical EES system, the orbit of a satellite is predicted by integrating output values of an equation of motion defined for the satellite. The last reliable position of the satellite that can be determined with the ephemeris data may be utilized as an initial state of the orbit for the integration. The predictions of the orbit of a satellite provided by an EES can be formatted in various manners including as a continuous polynomial function, such as a spline or Hermitea polynomial function, as a piecewise continuous function or as a delta or differential correction to the broadcast ephemeris data or almanac, etc. The equation of motion may be referenced as a force model, as the equation is based on forces acting upon the satellite. Although the orbit of the satellite may be predicted most accurately by including all forces that have a distinguishable effect upon the satellite, the equation of motion generally includes only the forces that contribute most significantly to the position of the satellite, such as by including the gravitational forces of the earth, the sun and the moon, as well as solar radiation pressure.

Several Ephemeris Extension Services are available including the ephemeris extension technology included in the 3rd Generation Partnership Project (3GPP) standards beginning with Release8 and available for GPS, GLONASS and Galileo systems. This ephemeris extension technology provides differential corrections to a reference ephemeris. In addition, other types of Ephemeris Extension Services that are available include those provided by the HERE GNSS API from HERE Technologies as well as GPSOneXtra from Qualcomm Technologies, Inc., Long-Term Orbit (LTO) from Broadcom Inc. and Predicted GPS (PGPS) from RX Networks, Inc. These other types of Ephemeris Extension Services also allow the ephemeris lifetime to be extended, such as for several days or even weeks.

By relying upon predictions of the orbit and clock of a navigation satellite that are provided by use of ephemeris extension, a GNSS receiver can reduce the instances in which delays are incurred in conjunction with the acquisition of navigation data via radio signals broadcast by the navigation satellites, thereby also reducing the TTFF. In addition, a GNSS receiver need not maintain a network connection as consistently in order to receive navigation data and correspondingly can reduce any network charges otherwise attributable to the provision of the network data via the network connection. As a result, the reliance upon ephemeris extension permits a GNSS receiver to continue to operate for a period of time in weak signal conditions and also in the absence of a consistent network connection. Moreover, by predicting the navigation satellite signal frequencies and code phases with extended ephemeris, a GNSS receiver can acquire weak ranging signals from a navigation satellite, thereby again reducing the TTFF.

However, the accuracy of the predictions of the position of a navigation satellite beyond the lifetime of the ephemeris data that are provided by ephemeris extension is increasingly diminished as more time passes since the expiration of the lifetime of the most recent ephemeris data. To improve the performance of GNSS positioning, the position of the navigation satellite at different points in time that is predicted based upon ephemeris extension can be corrected.

Various techniques that are utilized to improve the performance of GNSS-based positioning include differential GNSS (d-GNSS), real-time-kinematic technology (RTK) and precise point positing (PPP), as well as techniques that combine other positioning sources to improve performance such as inertial sensor integration, and the analysis of Wi-Fi or Bluetooth signals. In regards to a PPP-based correction service, a network of reference stations receives navigation data from navigation satellites and correction data is determined based thereupon including corrections for the orbit and clock, e.g., clock offset, of a navigation satellite, corrections of the code biases and corrections of the ionospheric models. This correction data may then be provided, such as via network connections, to one or more location-aware devices.

Correction data related to the orbit and clock of a navigation satellite is generally provided to a GNSS receiver relatively frequently, such as every 5 to 30 seconds. Additional types of correction data, such as correction data relating to code biases and ionospheric models, may also be provided, albeit less frequently. As the number of navigation satellite systems and correspondingly the number of navigation satellites increase, the quantity of correction data to be transmitted also increases. This increase in the quantity of correction data may be disadvantageous, however, as an increase in the quantity of correction data may require that a network connection be maintained more frequently and/or for greater lengths of time, may incur increased network charges, particularly when roaming abroad, and may increase the resources of the GNSS receiver that are consumed in relation to receiving, storing and/or processing the increased quantity of correction data.

### BRIEF SUMMARY

A method, apparatus and computer program product are disclosed in order to provide navigation-data parameters and/or correction-model parameters, such as the navigation-data parameters having correction data embedded therein, relating to one or more navigation satellites to one or more navigation devices. As the navigation-data parameters and/or the correction-model parameters have been fit to predicted data relating to the orbit and the clock that have been predicted for a respective navigation satellite, the navigation device may determine the position of the navigation satellite at various points in time so as to permit the position of the navigation device to be correspondingly determined without requiring that correction data be provided as frequently. Thus, the method, apparatus and computer program product of an example embodiment reduce the time during which the navigation device must maintain a network connection to allow for the receipt of the correction data and similarly reduce the resources of the navigation device that are otherwise required to receive, store and process the correction data. Additionally, in embodiments in which navigation-data parameters are fit to the predicted data regarding the orbit and the clock of a respective satellite, the method, apparatus and computer program product of an example embodiment reduce the quantity of data, namely, the correction data, transmitted to and received by the navigation device as the navigation-data parameters have already been fit in a manner that embeds the correction data therein. Thus, the correction data need not be separately provided to the navigation device, at least not as frequently.

In an example embodiment, a method is disclosed for providing one or more of navigation-data parameters or correction-model parameters for one or more navigation satellites. The method includes receiving (i) navigation data regarding one or more of a position of a respective navigation satellite or a clock offset of a clock of the respective navigation satellite and (ii) correction data regarding corrections to one or more of the position or the clock offset of the respective navigation satellite. The method also includes predicting an orbit and the clock of the respective navigation satellite based on the navigation data and the correction data. In this regard, the method predicts the orbit and the clock of the respective navigation satellite by determining predicted data comprising a plurality of data samples representing the clock and the orbit of the respective navigation satellite. The method further includes fitting at least one of the navigation-data parameters or the correction-model parameters to the predicted data and, following the fitting, providing the at least one of the navigation-data parameters or the correction-model parameters to one or more navigation devices.

Based on the navigation data and the correction data, the method of an example embodiment determines a set of matching positions and corrections and a set of matching clock offsets and corrections. In this example embodiment, the method predicts the orbit and the clock of the respective navigation satellite by predicting the orbit and the clock of the respective navigation satellite based on the set of matching positions and corrections and the set of matching clock offsets and corrections. The method of an example embodiment also includes receiving other data in addition to the correction data. The other data includes one or more of earth orientation parameters, antenna phase center offsets, solar-radiation pressure parameters, notice advisories or outage information. In this example embodiment, the method predicts the orbit and the clock of the respective navigation satellite based on the other data.

The method of an example embodiment predicts the orbit and the clock of the respective navigation satellite by utilizing ephemeris extension initialized with the navigation data and the correction data to predict the orbit and the clock of the respective navigation satellite. In an example embodiment, the method provides the at least one of the navigation-data parameters or the correction-model parameters by providing the navigation-data parameters with the correction data embedded therein to the one or more navigation devices. The method of this example embodiment may provide the navigation-data parameters with the correction data embedded therein by providing the navigation-data parameters without separately providing the correction-model parameters to the one or more navigation devices. In an example embodiment, the method also includes providing information regarding a lifetime of the navigation-data parameters or the correction-model parameters to the one or more navigation devices.

In another example embodiment, an apparatus is disclosed that is configured to provide one or more of navigation-data parameters or correction-model parameters for one or more navigation satellites. The apparatus includes processing circuitry and at least one non-transitory memory including computer program code instructions stored therein with the computer program code instructions configured to, when executed by the processing circuitry, cause the apparatus at least to receive (i) navigation data regarding one or more of a position of a respective navigation satellite or a clock offset of a clock of the respective navigation satellite and (ii) correction data regarding corrections to one or more of the position or the clock offset of the respective navigation satellite. The computer program code instructions are also configured to, when executed by the processing circuitry, cause the apparatus to predict an orbit and the clock of the respective navigation satellite based on the navigation data and the correction data. In this regard, the apparatus is caused to predict the orbit and the clock of the respective navigation satellite by determining predicted data including a plurality of data samples representing the clock and the orbit of the respective navigation satellite. The computer program code instructions are further configured to, when executed by the processing circuitry, cause the apparatus to fit at least one of the navigation-data parameters or the correction-model parameters to the predicted data and, following the fitting, to provide the at least one of the navigation-data parameters or the correction-model parameters to one or more navigation devices.

The computer program code instructions are also configured to, when executed by the processing circuitry, cause the apparatus of an example embodiment to determine, based on the navigation data and the correction data, a set of matching positions and corrections and a set of matching clock offsets and corrections. The apparatus of this example embodiment is caused to predict the orbit and the clock of the respective navigation satellite by predicting the orbit and the clock of the respective navigation satellite based on the set of matching positions and corrections and the set of matching clock offsets and corrections. The computer program code instructions are further configured to, when executed by the processing circuitry, cause the apparatus of an example embodiment to receive other data in addition to the correction data. The other data includes one or more of earth orientation parameters, antenna phase center offsets, solar-radiation pressure parameters, notice advisories or outage information. The apparatus of this example embodiment is caused to predict the orbit and the clock of the respective navigation satellite by predicting the orbit and the clock of the respective navigation satellite also based on the other data. The apparatus of an example embodiment is caused to predict the orbit and the clock of the respective navigation satellite by utilizing ephemeris extension initialized with the navigation data and the correction data to predict the orbit and the clock of the respective navigation satellite.

The apparatus of an example embodiment is caused to provide the at least one of the navigation-data parameters or the correction-model parameters by providing the navigation-data parameters with the correction data embedded therein to the one or more navigation devices. In this example embodiment, the apparatus may be caused to provide the navigation-data parameters with the correction data embedded therein by providing the navigation-data parameters without separately providing the correction-model parameters to the one or more navigation devices. The computer program code instructions are further configured to, when executed by the processing circuitry, cause the apparatus of an example embodiment to provide information regarding a lifetime of the navigation-data parameters or the correction-model parameters to the one or more navigation devices.

In a further example embodiment, a computer program product is disclosed that is configured to provide one or more of the navigation-data parameters or correction-model parameters for one or more navigation satellites. The computer program product includes at least one non-transitory computer-readable storage medium having computer-executable program code instructions stored therein with the computer-executable program code instructions including program code instructions configured to receive (i) navigation data regarding one or more of a position of a respective navigation satellite or a clock offset of a clock of the respective navigation satellite and (ii) correction data regarding corrections to one or more of the position or the clock offset of the respective navigation satellite. The computer-executable program code instructions also include program code instructions configured to predict an orbit and the clock of the respective navigation satellite based on the navigation data and the correction data. The program code instructions configured to predict the orbit and the clock of the respective navigation satellite include program code instructions configured to determine predicted data including a plurality of data samples representing the clock and the orbit of the respective navigation satellite. The computer-executable program code instructions further include program code instructions configured to fit at least one of the navigation-data parameters or the correction-model parameters to the predicted data and program code instructions configured to provide, following the fitting, the at least one of the navigation-data parameters or the correction-model parameters to one or more navigation devices.

The computer-executable program code instructions of an example embodiment also include program code instructions configured to determine, based on the navigation data and the correction data, a set of matching positions and corrections and a set of matching clock offsets and corrections. In this example embodiment, the program code instructions configured to predict the orbit and the clock of the respective navigation satellite include program code instructions configured to predict the orbit and the clock of the respective navigation satellite based on the set of matching positions and corrections and the set of matching clock offsets and corrections. The computer-executable program code instructions of an example embodiment further include program code instructions configured to receive other data in addition to the correction data. The other data includes one or more of earth orientation parameters, antenna phase center offsets, solar-radiation pressure parameters, notice advisories or outage information. In this example embodiment, the program code instructions configured to predict the orbit and the clock of the respective navigation satellite include program code instructions configured to predict the orbit and the clock of the respective navigation satellite also based on the other data.

The program code instructions that are configured to predict the orbit and the clock of the respective navigation satellite in accordance with an example embodiment include program code instructions configured to utilize ephemeris extension initialized with the navigation data and the correction data to predict the orbit and the clock of the respective navigation satellite. In an example embodiment, the program code instructions configured to provide the at least one of the navigation-data parameters or the correction-model parameters include program code instructions configured to provide the navigation-data parameters with the correction data embedded therein to the one or more navigation devices. In this example embodiment, the program code instructions may be configured to provide the navigation-data parameters with the correction data embedded therein without separately providing the correction-model parameters to the one or more navigation devices. The computer-executable program code instructions of an example embodiment further include program code instructions configured to provide information regarding a lifetime of the navigation-data parameters or the correction-model parameters to the one or more navigation devices.

In yet another example embodiment, an apparatus is disclosed that is configured to provide one or more of navigation-data parameters or correction-model parameters for one or more navigation satellites. The apparatus includes means for receiving (i) navigation data regarding one or more of a position of a respective navigation satellite or a clock offset of a clock of the respective navigation satellite and (ii) correction data regarding corrections to one or more of the position or the clock offset of the respective navigation satellite. The apparatus also includes means for predicting an orbit and the clock of the respective navigation satellite based on the navigation data and the correction data. In this regard, the means for predicting the orbit and the clock of the respective navigation satellite includes means for determining predicted data comprising a plurality of data samples representing the clock and the orbit of the respective navigation satellite. The apparatus further includes means for fitting at least one of the navigation-data parameters or the correction-model parameters to the predicted data and, following the fitting, means for providing the at least one of the navigation-data parameters or the correction-model parameters to one or more navigation devices.

Based on the navigation data and the correction data, the apparatus of an example embodiment includes means for determining a set of matching positions and corrections and a set of matching clock offsets and corrections. In this example embodiment, the means for predicting the orbit and the clock of the respective navigation satellite includes means for predicting the orbit and the clock of the respective navigation satellite based on the set of matching positions and corrections and the set of matching clock offsets and corrections. The apparatus of an example embodiment also includes means for receiving other data in addition to the correction data. The other data includes one or more of earth orientation parameters, antenna phase center offsets, solar-radiation pressure parameters, notice advisories or outage information. In this example embodiment, the means for predicting the orbit and the clock of the respective navigation satellite does so based on the other data.

The means for predicting the orbit and the clock of the respective navigation satellite in accordance with an example embodiment includes means for utilizing ephemeris extension initialized with the navigation data and the correction data to predict the orbit and the clock of the respective navigation satellite. In an example embodiment, the means for providing the at least one of the navigation-data parameters or the correction-model parameters includes means for providing the navigation-data parameters with the correction data embedded therein to the one or more navigation devices. In this example embodiment, the means for providing the navigation-data parameters with the correction data embedded therein includes means for providing the navigation-data parameters without separately providing the correction-model parameters to the one or more navigation devices. In an example embodiment, the apparatus also includes means for providing information regarding a lifetime of the navigation-data parameters or the correction-model parameters to the one or more navigation devices.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 illustrates a system in which navigation-data parameters and/or correction-model parameters are provided to a navigation device based on navigation data provided by a navigation satellite and correction data provided by a correction service in accordance with an example embodiment;

FIG. 2 is a block diagram of an apparatus that may be specifically configured in accordance with an example embodiment of the present disclosure;

FIG. 3 is a flowchart illustrating the operations performed, such as by the apparatus of FIG. 2, in accordance with an example embodiment of the present disclosure; and

FIG. 4 is another block diagram of an apparatus in accordance with an example embodiment of the present disclosure which depicts at least some of the operations performed by the apparatus.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are disclosed for providing one or more of navigation-data parameters or correction-model parameters, such as navigation-data parameters having correction data embedded therein, for one or more navigation satellites to one or more navigation devices. Utilizing the navigation-data parameters and/or the correction-model parameters, a navigation device is able to determine the position of a navigation satellite at one or more instances in time and based upon the location of the navigation satellite at one or more instances in time determine the position of the navigation device itself. As described below, by relying upon navigation-data parameters and/or correction-model parameters that have been fit to predicted data relating to the orbit and the clock of the navigation satellite, the navigation-data parameters and/or the correction-model parameters permit the location of the navigation satellite to be determined in an accurate manner and to rely upon or use less correction data than typically utilized. As a result, the method, apparatus and computer program product of an example embodiment permit less data, such as less correction data, to be transmitted to and received by the navigation device and for such correction data to be provided less frequently, thereby reducing the need for the navigation device to maintain a consistent network connection and reducing network charges otherwise levied for the transmission of data, such as correction data, to the navigation device.

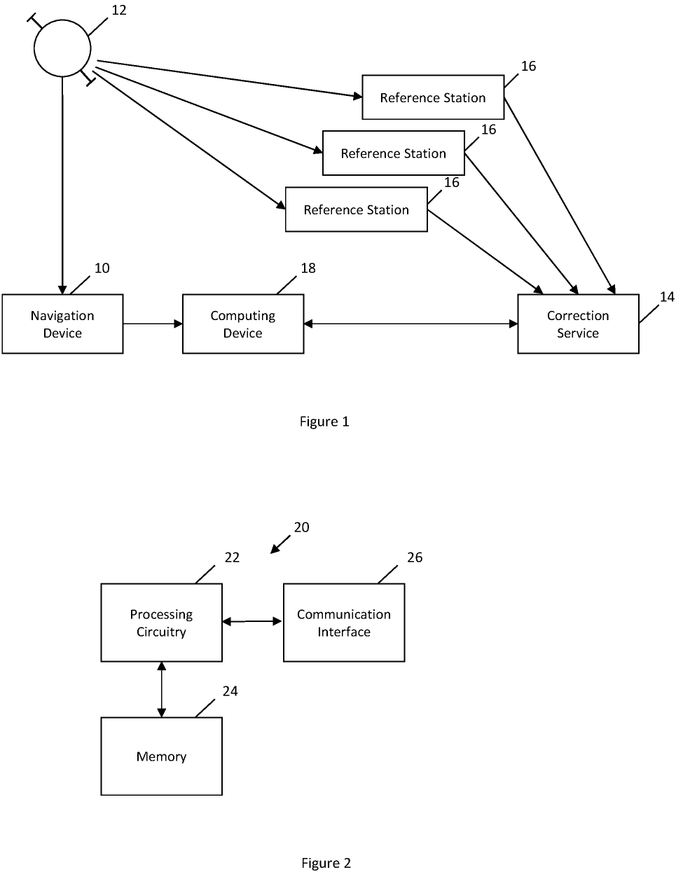

Referring now to FIG. 1, a navigation device 10 is depicted to receive data broadcast by a navigation satellite 12. Although a single navigation satellite 12 is depicted for purposes of illustration, the navigation satellite is typically one of a constellation of navigation satellites that orbit the earth. For example, the navigation satellite may be a GNSS satellite, such as a GPS satellite, a GLONASS satellite, a Beidou satellite, a Galileo satellite or a regional SBAS satellite. Regardless of the type of navigation satellite, the navigation satellite provides signals, such as on a periodic basis, that includes a ranging code and ephemeris data interleaved with the ranging code that defines the orbit of the navigation satellite for the lifetime of the ephemeris data, such as for a predefined period of time, e.g., 2 to 4 hours. Based upon the ephemeris data, the position of the navigation satellite may be determined within the predefined period of time.

Although FIG. 1 depicts a single navigation device 10, the navigation satellite 12 may broadcast data to a plurality of navigation devices in other embodiments. The navigation device may be embodied by any of a variety of devices including, for example, a mobile device, such as a mobile terminal, e.g., a personal digital assistant (PDA), mobile telephone, smart phone, personal navigation device, smart watch, tablet computer, or any combination of the aforementioned and other types of portable computer devices including an IOT device that includes a GNSS receiver, or a positioning or navigation system such as a positioning or navigation system onboard a vehicle, e.g., an automobile, a truck, a drone, a train, etc. Regardless of the manner in which the navigation device is embodied, the navigation device is generally configured to predict the position of the navigation satellite, such as the orbit and/or the clock of the navigation satellite, at one or more points in time within a prediction interval. The prediction interval may extend temporally beyond a predefined period of time during which the ephemeris data is valid so as to predict the position of the navigation satellite at each of a plurality of points in time following the lifetime of the ephemeris data. Although the navigation device may be configured to predict the position of the navigation satellite at the plurality of points in time within the prediction interval in any of a variety of different manners, the navigation device of an example embodiment is configured to predict the position of the navigation satellite utilizing a prediction algorithm, such as a prediction algorithm that provides an ephemeris extension of the ephemeris data.

In order to more accurately determine the position the navigation satellite 12 and, in turn, the position of the navigation device 10, the navigation device is also configured to determine its position not only based upon the predicted position of the navigation satellite at a respective point in time, but also a correction to the predicted orbit and/or clock, such as a clock offset relative to the GNSS clock, of the navigation satellite. As such, the navigation device of an example embodiment is also configured to communicate with, such as by receiving correction data from, a correction service 14. Although various types of correction services can provide the correction data to the navigation device, one example of a correction service is a correction service that provides correction data pursuant to a PPP technique. Although a correction service may be embodied in a variety of different manners, the correction service of the example of FIG. 1 includes a plurality of reference stations 16 located at different positions and configured to receive ephemeris data from the navigation satellite. Based upon the ephemeris data received by the plurality of reference stations, the correction service can determine correction data that provides corrections to the orbit and clock, such as a clock offset, that are predicted for the navigation satellite based upon the ephemeris data received by the navigation device. Although the correction data can be provided in various manners, the correction data is provided by the correction service to the navigation device in accordance with one embodiment via a network connection.

The apparatus of an example embodiment that is configured to provide navigation-data parameters or correction-model parameters, such as navigation-data parameters with correction data embedded therein, to one or more navigation devices 10 may be embodied by a computing device 18, such as, for example, a server, a cloud computing device, a computer workstation, a distributed network of computing devices, a personal computer, a positioning or navigation system or any other type of computing device. Although depicted in FIG. 1 to be separate from, but in communication with both the correction service 14 and the navigation device 10, the computing device embodying the apparatus of another example embodiment may be embodied by the correction service or be a navigation device. Regardless, the computing device is configured to receive navigation data and correction data, such as from the correction service and to provide navigation-data parameters and/or correction-model parameters to the navigation device. Regardless of the type of computing device that embodies the apparatus, the apparatus 20 of an example embodiment depicted by FIG. 2 includes processing circuitry 22, a memory device 24 and a communication interface 26.

In some embodiments, the processing circuitry 22 (and/or co-processors or any other processors assisting or otherwise associated with the processing circuitry) can be in communication with the memory device 24 via a bus for passing information among components of the apparatus 20. The memory device can be non-transitory and can include, for example, one or more volatile and/or non-volatile memories. In other words, for example, the memory device may be an electronic storage device (for example, a computer readable storage medium) comprising gates configured to store data (for example, bits) that can be retrievable by a machine (for example, a computing device like the processing circuitry). The memory device can be configured to store information, data, content, applications, instructions, or the like for enabling the apparatus to carry out various functions in accordance with an example embodiment of the present disclosure. For example, the memory device can be configured to buffer input data for processing by the processing circuitry. Additionally or alternatively, the memory device can be configured to store instructions for execution by the processing circuitry.

The processing circuitry 22 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally or alternatively, the processing circuitry can include one or more processors configured in tandem via the bus to enable independent execution of instructions, pipelining and/or multithreading.

In an example embodiment, the processing circuitry 22 can be configured to execute instructions stored in the memory device 24 or otherwise accessible to the processing circuitry. Alternatively or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 20 of an example embodiment can also include the communication interface 26. The communication interface can be any means such as a device or circuitry embodied in either hardware or a combination of hardware and software that is configured to receive and/or transmit data from/to other electronic devices in communication with the apparatus, such as by providing for communication with a correction service 14 and/or one or more navigation device(s) 10. The communication interface can be configured to communicate in accordance with various wireless protocols including Global System for Mobile Communications (GSM), such as but not limited to Long Term Evolution (LTE). In this regard, the communication interface can include, for example, an antenna (or multiple antennas) and supporting hardware and/or software for enabling communications with a wireless communication network. Additionally or alternatively, the communication interface can include the circuitry for interacting with the antenna(s) to cause transmission of signals via the antenna(s) or to handle receipt of signals received via the antenna(s). In some environments, the communication interface can alternatively or also support wired communication. In some embodiments, the apparatus 20 may be configured to support communication with one or more navigation satellites 12. As such, the communication interface of this example embodiment may also optionally include a satellite receiver, such as a GNSS receiver.

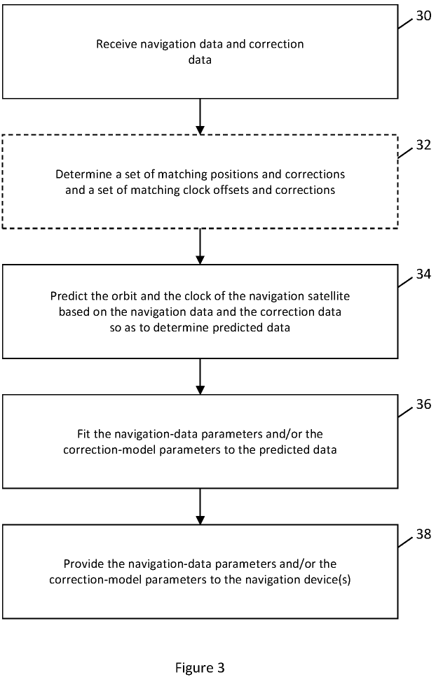

Referring now to FIG. 3, the operations performed, such as by the apparatus 20 of FIG. 2, in order to provide navigation-data parameters and/or correction-model parameters, such as navigation-data parameters having correction data embedded therein, for one or more navigation satellites 12 to one or more navigation devices 10 are depicted. As shown in block 30, the apparatus includes means, such as the communication interface 26, the processing circuitry 22 or the like, for receiving navigation data and correction data. In embodiments in which the apparatus, such as the communication interface, includes a receiver, such as GNSS receiver, the navigation data may be received from a respective navigation satellite, based upon signals transmitted by the navigation satellite and received by the receiver. In other example embodiments, however, the navigation data may be received from the correction service 14, from one or more reference stations 16 of the correction service or from another device that includes a receiver, such as a GNSS receiver, that has received the navigation data from the respective navigation satellite. The navigation data, known as ephemeris data, includes a set of parameter values of an orbit model defining the orbit of the navigation satellite for a limited period of time. As such, the navigation data defines the position of the navigation satellite, such as the orbit of the respective navigation satellite, and the clock offset of the clock of the respective navigation satellite relative to a reference clock, such as the clock of the GNSS system.

As to the correction data, the correction data may be received from the correction service 14 and, in an embodiment in which the computing device 18 that includes the apparatus 20 is embodied by the correction service, by processing circuitry of the correction service that is configured to determine the correction data, such as based upon the navigation data received by the plurality of reference stations 16. The correction data provides corrections to the position and/or the clock offset of the respective navigation satellite 12.

In an example embodiment, the apparatus 20 optionally includes means, such as the processing circuitry 22 or the like, for determining a set of matching positions and corrections and a set of matching clock offsets and corrections based upon the navigation data and the correction data for each of a plurality of instances in time. See block 32. Each set of matching positions and corrections and each set of matching clock offsets and corrections is associated with a respective instance in time, such as an instant in time following the time at which the navigation data was transmitted by the navigation satellite 12. In one example embodiment, the set of matching positions and corrections includes a position of the navigation satellite, a velocity of the navigation satellite and the correction to the position of the navigation satellite at a respective instant in time.

As shown in block 34 FIG. 3, the apparatus 20 also includes means, such as the processing circuitry 22 or the like, for predicting the orbit and the clock of the respective navigation satellite 12 based on the navigation data and the correction data. In this regard, the apparatus, such as the processing circuitry, is configured to predict the orbit and the clock of the respective navigation satellite by determining predicted data that includes a plurality of data samples representing the clock and the orbit of the respective navigation satellite, such as at different points in time. The plurality of data samples may be predicted during a predefined period of time representing the lifetime of the ephemeris data and/or following the predefined period of time utilizing a prediction algorithm, such as a prediction algorithm that provides an ephemeris extension of the ephemeris data. The data samples that are predicted are based not only upon the ephemeris data, but also based upon the correction data (e.g., the correction data provided by the correction service), such that the resulting predicted data takes into account and factors corrections to the navigation data over time. In an example embodiment in which a set of matching positions and corrections and a set of matching clock offsets and corrections are determined based upon the navigation data and the correction data for each of a plurality of instances in time, the apparatus, such as the processing circuitry, may be configured to predict the orbit and/or the clock of the respective navigation satellite based on the set of matching positions and corrections and the set of matching clock offsets and corrections at each of one or more instances in time.

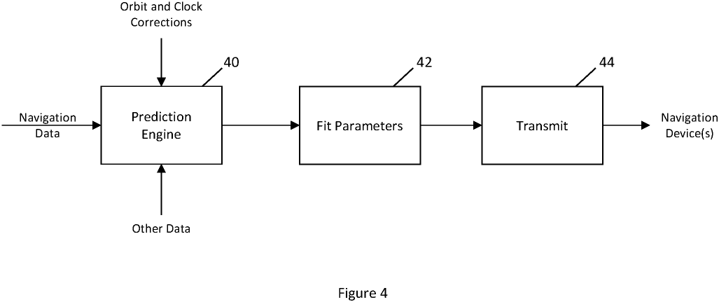

As shown in FIG. 4, one example of an apparatus 20 for providing navigation-data parameters and/or correction-model parameters for one or more navigation satellites 12 is depicted. In this example embodiment, the apparatus and, more particularly, the processing circuitry 22, includes a prediction engine 40 configured to predict the orbit and the clock of the respective navigation satellite based on the navigation data and the correction data. Although the orbit and the clock of the respective navigation satellite may be predicted in various manners, the apparatus, such as the processing circuitry and, more particularly, the prediction engine of an example embodiment is configured to predict the orbit and the clock of the respective navigation satellite by utilizing an ephemeris extension initialized with the navigation data and the correction data as shown in FIG. 4.

As shown in block 36 of FIG. 3 and block 42 of FIG. 4, the apparatus 20 also includes means, such as the processing circuitry 22 or the like, for fitting at least one of the navigation-data parameters or the correction-model parameters to the predicted data, such as in accordance with a fitting algorithm. As described below, the fitting algorithm may be configured to modify the navigation-data parameters or the correction-model parameters to best approximate predicted data, such as predicted navigation-data parameters or predicted correction-model parameters.

In an embodiment in which the navigation-data parameters are fit to the predicted data, the apparatus, such as the processing circuitry, is configured to modify at least some of the navigation-data parameters from those defined by the navigation data provided, for example, by the navigation satellite 12 so as to fit the predicted data, such as to best approximate the predicted data. As the predicted data is based not only upon the navigation data but upon the correction data, the predicted data takes into account the correction data and, as a result, fitting the navigation-data parameters to the predicted data in this example embodiment embeds the corrections to the position and/or the clock offset of the respective navigation satellite into the navigation-data parameters, as fitted, themselves.

In another example embodiment, the apparatus 20, such as the processing circuitry 22, is configured to fit the correction-model parameters to the predicted data by modifying the correction-model parameters from those defined by the correction data provided, for example, by a correction service 14. The predicted data that is utilized for purposes of fitting the correction-model parameters may be derived in various manners. For example, the prediction engine 40 may be configured to provide predictions for the orbit and clock corrections in a comparable manner to which the prediction engine derives the orbit and the clock offset. Alternatively, the apparatus, such as the processing circuitry, may embody a second instance of the prediction engine. In this alternative embodiment, one instance of the prediction engine is initialized with corrected data samples as described above, while the second instance of the prediction engine is initialized with the navigation data, but without any correction data. The correction-model parameters, such as the orbit and clock corrections, may then be derived from the difference between the matching data samples representing the orbit and clock offset provided by the two instances of the prediction engine. Regardless of the manner in which the predicted data is derived, the resulting correction-model parameters, as fitted, are configured to translate the navigation data provided by the navigation satellite 12 to the predicted data that is based not only upon the navigation data but the correction data.

The navigation-data parameters and/or the correction-model parameters are fit to the predicted data over a period of time following the time at which the navigation data is transmitted by the navigation satellite 12. In some embodiments, the navigation-data parameters and/or the correction-model parameters are fit to the predicted data over a period of time that extends beyond the predicted life of the ephemeris data and into the period of time in which the orbit and the clock of the navigation satellite is determined based upon an ephemeris extension.

As shown in block 38 of FIG. 3 and block 44 of FIG. 4, the apparatus 20 of this example embodiment also includes means, such as the processing circuitry 22, the communication interface 26 or the like, for providing at least one of the navigation-data parameters or the correction-model parameters, such as the navigation-data parameters having correction data embedded therein, to one or more navigation devices 10 following the fitting of the navigation-data parameters and/or the correction-model parameters to the predicted data. Based upon the navigation-data parameters and/or the correction-model parameters, such as the navigation-data parameters having correction data embedded therein, the navigation device may be configured to accurately predict the orbit and the clock, such as a clock offset, of the navigation satellite 12 at a plurality of instances in time, thereby defining the position of the navigation satellite at the plurality of instances in time. As the navigation-data parameters and/or the correction-model parameters that are provided have been predicted so as to be effective over a period of time and since the navigation-data parameters and/or the correction-model parameters are based upon and take into account the correction data regarding corrections to the position and/or the clock offset of the navigation satellite, the navigation device is therefore configured to predict the orbit and the clock, e.g., the clock offset, of the navigation satellite over the period of time during which the navigation-data parameters and/or the correction-model parameters are effective without further reference to correction data.

As a result, the navigation device 10 need not receive additional correction data during the period of time during which the navigation-data parameters and/or the correction-model parameters are effective, thereby reducing bandwidth requirements and correspondingly reducing the quantity of data that is received, stored and processed by the navigation device. As the correction data is typically provided via a network connection, the navigation device also need not maintain as consistent of a network connection following receipt of the navigation-data parameters and/or the correction-model parameters since the navigation device need not receive additional correction data, at least not as frequently. By way of example but not of limitation, the navigation device may be configured to receive navigation-data parameters and/or correction-model parameters in accordance with an example embodiment at a much lower frequency, such as every 2 hours, than the frequency with which correction data is provided by a conventional correction service, which may provide correction data every 5 to 30 seconds.

Additionally, in an embodiment in which the navigation-data parameters are fit to the predicted data, the corrections, such as the corrections to the position and/or the clock offset of the navigation satellite 12, are embedded within the navigation data parameters since the predicted data is based in part upon the correction data. As such, the apparatus 20, such as the processing circuitry 22, the communication interface 26 or the like, of this example embodiment is configured to provide navigation-data parameters with the correction data embedded therein to the one or more navigation devices 10. Since the navigation-data parameters have the correction data embedded therein, the apparatus, such as the processing circuitry, the communication interface or the like, is configured to provide the navigation-data parameters without separately providing the correction-model parameters to the one or more navigation devices. In this regard, the correction-model parameters need not be provided in this example embodiment as the correction-model parameters may not provide additional information since the corrections are embedded within the navigation data parameters. By conveying the corrections as embedded within the navigation-data parameters and without separately providing the correction-model parameters, the data that is to be provided to and processed by the navigation device is reduced, thereby conserving bandwidth and computing resources.

Additional information may be provided in conjunction with the navigation-data parameters or the correction-model parameters. For example, the apparatus 20 of an example embodiment includes means, such as the processing circuitry 22, the communication interface 26 or the like, for providing information regarding the lifetime of the navigation-data parameters or the correction-model parameters to the one or more navigation devices 10. The lifetime of the navigation-data parameters and/or the correction-model parameters define the period of time during which the navigation-data parameters and the correction-model parameters are effective and valid for use by the navigation device in order to predict the orbit and the clock of the navigation satellite.

As described above, the apparatus 20, such as the processing circuitry 22, is configured to receive navigation data and correction data from which the orbit and the clock, e.g., the clock offset, of a navigation satellite 12 is able to be predicted. In some example embodiments, the apparatus, such as the processing circuitry, is configured to receive other data in addition to the navigation data and the correction data and to utilize the other data to predict the orbit and the click of the navigation satellite. In this regard and as shown in FIG. 4, the apparatus of an example embodiment also includes means, such as the processing circuitry, the communication interface 26 or the like, for receiving other data in addition to the navigation data and the correction data with the other data including one or more of earth orientation parameters, antennae phase center offsets, solar-radiation pressure parameters, notice advisories or outage information. In this example embodiment, the apparatus, such as the processing circuitry, is then configured to predict the orbit and the clock, e.g., the clock offset, of the respective navigation satellite based not only upon the navigation data and the correction data as described above, but also based upon the other data, such as the earth orientation parameters, the antenna phase center offsets, the solar-radiation pressure parameters, notice advisories and/or outage information. As a result, the orbit and the clock of the respective navigation satellite may be predicted in accordance with this example embodiment with increased accuracy.

As described above, FIGS. 3 and 4 are flowcharts of an apparatus 20, method, and computer program product configured to determine the position of a navigation satellite 12 according to an example embodiment. It will be understood that each block of the flowcharts, and combinations of blocks in the flowcharts, may be implemented by various means, such as hardware, firmware, processing circuitry 22, and/or other devices associated with execution of software including one or more computer program instructions. For example, one or more of the procedures described above may be embodied by computer program instructions. In this regard, the computer program instructions which embody the procedures described above may be stored by the memory device 24 of the apparatus and executed by the processing circuitry or the like. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for providing one or more of navigation-data parameters or correction-model parameters for one or more navigation satellites, the method comprising:
receiving (i) navigation data regarding one or more of a position of a respective navigation satellite or a clock offset of a clock of the respective navigation satellite and (ii) correction data regarding corrections to one or more of the position or the clock offset of the respective navigation satellite;
predicting an orbit and the clock of the respective navigation satellite based on the navigation data and the correction data, wherein predicting the orbit and the clock of the respective navigation satellite comprises determining predicted data comprising a plurality of data samples representing the clock and the orbit of the respective navigation satellite;
fitting at least one of the navigation-data parameters or the correction-model parameters to the predicted data; and
following the fitting, providing the at least one of the navigation-data parameters or the correction-model parameters to one or more navigation devices.

2. A method according to claim 1, further comprising:
based on the navigation data and the correction data, determining a set of matching positions and corrections and a set of matching clock offsets and corrections,
wherein predicting the orbit and the clock of the respective navigation satellite comprises predicting the orbit and the clock of the respective navigation satellite based on the set of matching positions and corrections and the set of matching clock offsets and corrections.

3. A method according to claim 1, further comprising:
receiving other data in addition to the correction data, the other data comprising one or more of earth orientation parameters, antenna phase center offsets, solar-radiation pressure parameters, notice advisories or outage information,
wherein predicting the orbit and the clock of the respective navigation satellite comprises predicting the orbit and the clock of the respective navigation satellite also based on the other data.

4. A method according to claim 1, wherein predicting the orbit and the clock of the respective navigation satellite comprises utilizing ephemeris extension initialized with the navigation data and the correction data to predict the orbit and the clock of the respective navigation satellite.

5. A method according to claim 1, wherein providing the at least one of the navigation-data parameters or the correction-model parameters comprises providing the navigation-data parameters with the correction data embedded therein to the one or more navigation devices.

6. A method according to claim 5, wherein providing the navigation-data parameters with the correction data embedded therein comprises providing the navigation-data parameters without also providing the correction-model parameters to the one or more navigation devices.

7. A method according to claim 1, further comprising providing information regarding a lifetime of the navigation-data parameters or the correction-model parameters to the one or more navigation devices.

8. An apparatus configured to provide one or more of navigation-data parameters or correction-model parameters for one or more navigation satellites, the apparatus comprising processing circuitry and at least one non-transitory memory including computer program code instructions stored therein, the computer program code instructions configured to, when executed by the processing circuitry, cause the apparatus at least to:
receive (i) navigation data regarding one or more of a position of a respective navigation satellite or a clock offset of a clock of the respective navigation satellite and (ii) correction data regarding corrections to one or more of the position or the clock offset of the respective navigation satellite;
predict an orbit and the clock of the respective navigation satellite based on the navigation data and the correction data, wherein the apparatus is caused to predict the orbit and the clock of the respective navigation satellite by determining predicted data comprising a plurality of data samples representing the clock and the orbit of the respective navigation satellite;
fit at least one of the navigation-data parameters or the correction-model parameters to the predicted data; and
following the fitting, provide the at least one of the navigation-data parameters or the correction-model parameters to one or more navigation devices.

9. An apparatus according to claim 8, wherein the computer program code instructions are further configured to, when executed by the processing circuitry, cause the apparatus to:
based on the navigation data and the correction data, determine a set of matching positions and corrections and a set of matching clock offsets and corrections,
wherein the apparatus is caused to predict the orbit and the clock of the respective navigation satellite by predicting the orbit and the clock of the respective navigation satellite based on the set of matching positions and corrections and the set of matching clock offsets and corrections.

10. An apparatus according to claim 8, wherein the computer program code instructions are further configured to, when executed by the processing circuitry, cause the apparatus to:
receive other data in addition to the correction data, the other data comprising one or more of earth orientation parameters, antenna phase center offsets, solar-radiation pressure parameters, notice advisories or outage information,
wherein the apparatus is caused to predict the orbit and the clock of the respective navigation satellite by predicting the orbit and the clock of the respective navigation satellite also based on the other data.

11. An apparatus according to claim 8, wherein the apparatus is caused to predict the orbit and the clock of the respective navigation satellite by utilizing ephemeris extension initialized with the navigation data and the correction data to predict the orbit and the clock of the respective navigation satellite.

12. An apparatus according to claim 8, wherein the apparatus is caused to provide the at least one of the navigation-data parameters or the correction-model parameters by providing the navigation-data parameters with the correction data embedded therein to the one or more navigation devices.

13. An apparatus according to claim 12, wherein the apparatus is caused to provide the navigation-data parameters with the correction data embedded therein by providing the navigation-data parameters without separately providing the correction-model parameters to the one or more navigation devices.

14. An apparatus according to claim 8, wherein the computer program code instructions are further configured to, when executed by the processing circuitry, cause the apparatus to provide information regarding a lifetime of the navigation-data parameters or the correction-model parameters to the one or more navigation devices.

15. A computer program product configured to provide one or more of the navigation-data parameters or correction-model parameters for one or more navigation satellites, the computer program product comprising at least one non-transitory computer-readable storage medium having computer-executable program code instructions stored therein, the computer-executable program code instructions comprising program code instructions configured to:
receive (i) navigation data regarding one or more of a position of a respective navigation satellite or a clock offset of a clock of the respective navigation satellite and (ii) correction data regarding corrections to one or more of the position or the clock offset of the respective navigation satellite;
predict an orbit and the clock of the respective navigation satellite based on the navigation data and the correction data, wherein the program code instructions configured to predict the orbit and the clock of the respective navigation satellite comprise program code instructions configured to determine predicted data comprising a plurality of data samples representing the clock and the orbit of the respective navigation satellite;
fit at least one of the navigation-data parameters or the correction-model parameters to the predicted data; and
following the fitting, provide the at least one of the navigation-data parameters or the correction-model parameters to one or more navigation devices.

16. A computer program product according to claim 15, wherein the computer-executable program code instructions further comprise program code instructions configured to:
based on the navigation data and the correction data, determine a set of matching positions and corrections and a set of matching clock offsets and corrections,
wherein the program code instructions configured to predict the orbit and the clock of the respective navigation satellite comprise program code instructions configured to predict the orbit and the clock of the respective navigation satellite based on the set of matching positions and corrections and the set of matching clock offsets and corrections.

17. A computer program product according to claim 15, wherein the computer-executable program code instructions further comprise program code instructions configured to:
receive other data in addition to the correction data, the other data comprising one or more of earth orientation parameters, antenna phase center offsets, solar-radiation pressure parameters, notice advisories or outage information,
wherein the program code instructions configured to predict the orbit and the clock of the respective navigation satellite comprise program code instructions configured to predict the orbit and the clock of the respective navigation satellite also based on the other data.

18. A computer program product according to claim 15, wherein the program code instructions configured to predict the orbit and the clock of the respective navigation satellite comprise program code instructions configured to utilize ephemeris extension initialized with the navigation data and the correction data to predict the orbit and the clock of the respective navigation satellite.

19. A computer program product according to claim 15, wherein the program code instructions configured to provide the at least one of the navigation-data parameters or the correction-model parameters comprise program code instructions configured to provide the navigation-data parameters with the correction data embedded therein to the one or more navigation devices.

20. A computer program product according to claim 15, wherein the computer-executable program code instructions further comprise program code instructions configured to provide information regarding a lifetime of the navigation-data parameters or the correction-model parameters to the one or more navigation devices.
